(19) United States
(12) Patent Application Publication
(10) Pub. No.: US 2025/0185552 A1
(43) Pub. Date: Jun. 12, 2025

(54) HORTICULTURE SEGMENTED LIGHTING SYSTEMS

(71) Applicant: INVENT10 LIMITED, Hong Kong (CN)

(72) Inventor: Man Tung Lo, Hong Kong (CN)

(73) Assignee: INVENT10 LIMITED, Hong Kong (CN)

(21) Appl. No.: 18/531,698

(22) Filed: Dec. 7, 2023

(51) Int. Cl. A01G 9/24; F21S 2/00; F21Y 103/10; F21Y 107/20; F21Y 113/00

(52) U.S. Cl. CPC A01G 9/249; F21S 2/005; F21Y 2103/10; F21Y 2107/20; F21Y 2113/00

(57) ABSTRACT

A lighting element is designed for horticultural lighting. The lighting element comprises a body for housing one or more lighting units, and the body comprises one or more lighting segments. Each of the lighting segments comprises the one or more lighting units. The one or more lighting units may be disposed on each of the lighting segments comprise one or more corresponding lens for directing beams of light. The lighting segments may be configured at various angles as a function of the vegetation subjected to the beams of light.

### BACKGROUND

Artificial light is a critical component for both indoor and greenhouse horticulture. The evenness of light distribution patterns could determine a given crop's quality, overall yield and efficiency.

Current designs of lighting systems typically have limited approaches to solving various common issues. For example, FIG. 1 illustrates a common problem dealing with indoor or greenhouse horticulture is the dark zone or shadow between isles of crops. For example, a typical greenhouse may place arrays or isles of plants at different heights. As such, the typical implementations involve hanging or placing the lights high up in the ceiling such as up to eight meters high directly above the arrays or isles of plants so that the plants may be exposed to as much light rays as possible. However, as shown in FIG. 1, the dark zones or shadow areas between the plants would mean that parts of the plants may not be exposed to the same amount of light.

One potential solution is to employ a set of intercanopy lamps so that light rays may shine directly at regions of the dark zones. However, the placements of these intercanopy lamps would need to be positioned close to the plants and would require a vast number of these lamps to be effective.

Another solution includes placing standing lights on the isles between the plants. However, such placements of standing lights impede or block the paths where workers may be moving along the same paths. Thus, these standing lights would not only be costly to implement, but also could potentially create hazardous working conditions for the workers.

Therefore, a better approach to solve such problems is needed.

### SUMMARY

Aspects of the invention improve over prior approaches by dividing a given lighting panel surface to different zones or segments such that placements of the lighting units may be further configured or controlled. In another embodiment, aspects of the invention may provide each of the lighting units may include a cover or lens. In another embodiment, the cover or lens may have a different refractive index such that the different lighting units in different segments or zones may reflect the light rays at different angles. In yet another embodiment, the lighting units may emit different light at different spectrums so as to accommodate the different plants or vegetation.

In yet another embodiment, the light distribution pattern may be programmed and adjust dynamically according to height of the plants and the environmental light distribution.

### BRIEF DESCRIPTION OF THE DRAWINGS

FIG. 1 illustrates a diagram illustrating dark zones experienced by plants due to existing lighting arrangements.

FIG. 2 illustrates a perspective view of a lighting system according to one embodiment.

FIG. 3 illustrates a first diagram showing a plant exposing to light at different angles from the lighting system according to one embodiment.

FIG. 4 illustrates a second diagram showing an array of plants exposing to light from the lighting system according to one embodiment.

FIG. 5 illustrates a diagram showing arrays of light targeting various parts of plants from the lighting system according to one embodiment.

FIGS. 6A and 6B illustrates diagrams of another design of the lighting system according to one embodiment.

FIGS. 7A to 7C illustrate diagrams showing light projection paths according to the another design of the lighting system.

FIGS. 8A to 8C illustrate diagrams of yet another embodiment of the lighting system according to one embodiment.

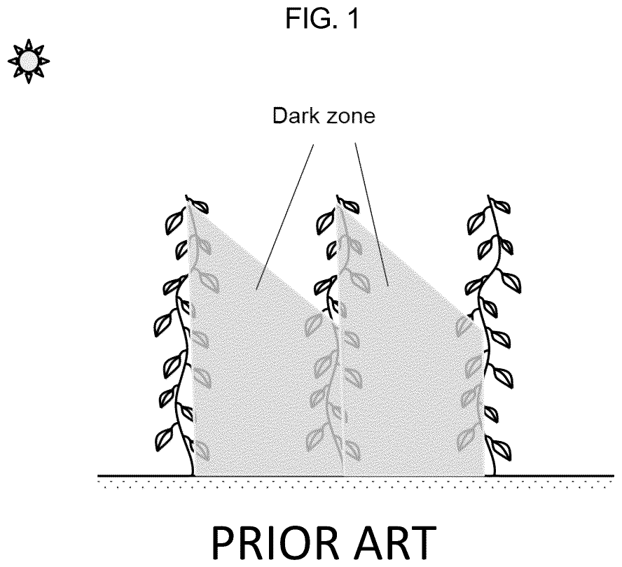

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

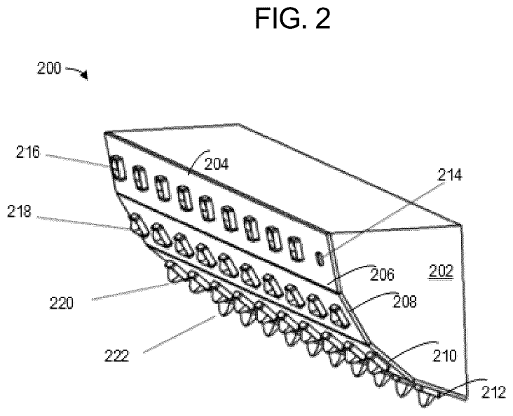

Referring now to FIG. 2, a diagram illustrates a system 200 according to one embodiment. In one example, the system or device 200 may include a body 202. In one aspect, the body 202 may be a housing for housing one or more components or electrical elements for the LED lights. In one embodiment, the body 202 may include at least an outward facing surface 204 for including one or more LED lights. In one embodiment, the outward facing surface 204 may include one or more panels. In one aspect, the surface 204 may include at least one panels. For example, the surface 204 may include a first panel 206, a second panel 208, a third panel 210, and a fourth panel 212. In one example, the first panel 206 may include an array of LED lights, such as the LED light 214. In one embodiment, the LED light 214 may include a lens. In one example, the one or more LED lights in the panel 206 may each include a lens 216. In one example, the lens 216 may be of a beam angle of 30° vertical (V)×90° horizontal (H) that covers the LED light, such as the LED light 214. In one aspect, the LED lights in the second panel 208 may each include a lens 218, that of a beam angle of 8° (V)×60° (H) that covers the LED lights in the second panel 208.

Similarly, the LED lights in the third panel 210 may each include a lens 220 for each of the LED lights in the third panel 210. In one example, the lens 220 may have a beam angle of 5° (V)×45° (H). Further, the fourth panel 212 may include a lens 222 with a beam angle of 3° (V)×35° (H) to cover each of the LED lights.

It is to be understood that, as indicated, the lens size and power may be programmed and adjusted accordingly. In another embodiment, the panels may have different vertical beam angle.

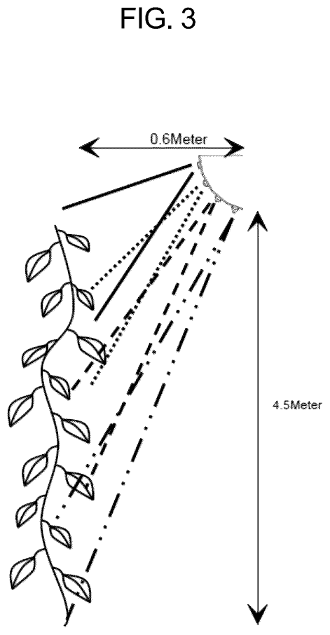

In another embodiment, FIG. 3 illustrates a diagram showing an exemplary placement of a LED lighting system, such as the one in FIG. 2. In one aspect, as shown in FIG. 3, the LED lighting system 200 may be placed above a 4 meter tall times 2.5 meter wide plant. In this example, the system 200 may be positioned at a height of 4.5 meters and the system 200 may be of 0.6 meters to plant in horizontal distance.

In another example, the top LED segment or panel of the system 200 may distribute light on the top region of the plant, which is closer to the plant, while the lower LED segment or panel may distribute light on the lower region of the plant and have a longer distance from the plant.

In another embodiment, to achieve an even light density along the whole plant, the top LED segment or panel may have the widest beam angle and the bottom LED segment or panel may have the narrowest beam angle.

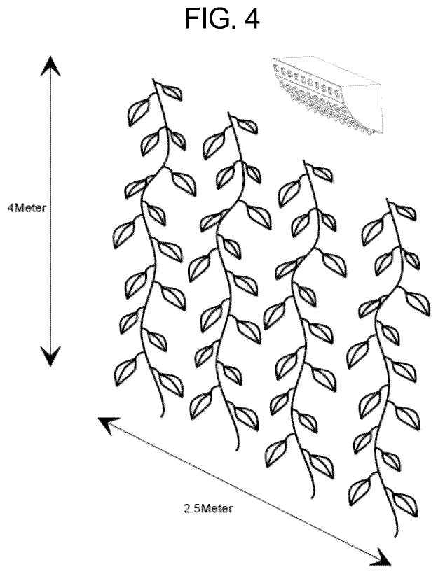

In another embodiment in FIG. 4, the system 200 may be positioned to face an array of plants that may be positioned in a span of 2.5-meter in width and about 4 meters in height.

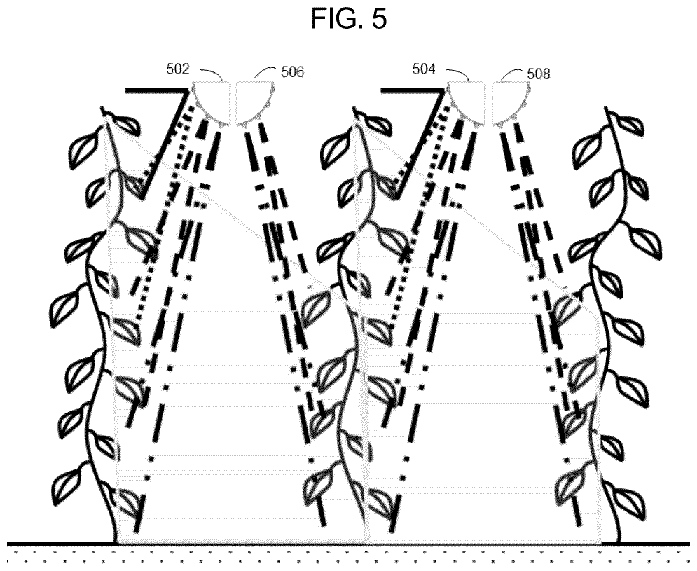

Referring to another embodiment, FIG. 5 illustrates another diagram showing another configuration with the system 200 according to one embodiment. For example, systems 502, 506 and systems 504, 508 may be positioned between isles of plants. While FIG. 2 illustrates the system 200 with four segments or panels with different lens to provide varying beam light angles, it is to be understood that the systems 502, 504, 506 and 508 may be programmed and configured to have different lens for the LED lights.

In one aspect, the brightness of different segment may be controlled according to the amount of sun light at different plant's region. In one example, it may avoid excess light on the region facing to the sun and supply enough light to the region under the shadow.

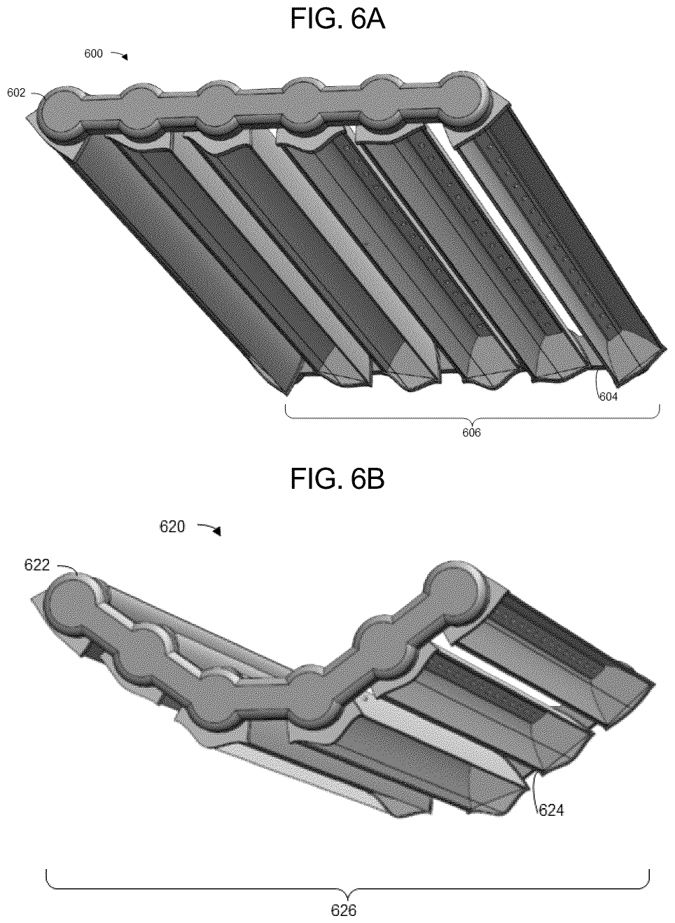

Referring now to FIGS. 6A and 6B, diagrams illustrate another embodiment of the LED lighting system according to one embodiment. In one example, FIG. 6A may include a configuration where a system 600 that may include one or more bars of LED lights 606 held between a set end pieces 602 and 604. In this example, there are six bars between the end pieces 602 and 604. It is to be understood that other number of bars may be used or applied without departing from the scope or spirit of the invention. In one aspect, the end pieces 602 and 604 may enable each of the bars 606 to rotate about its ends to adjust the angles. FIG. 6A illustrates three different beam angles.

In one embodiment, a tilt angle of each of the bars 606 may manually adjusted and secured by screws or dynamically controlled by a build-in servo motor mounting on the edge of the light bars. In another embodiment, the number of LED bar is not limited, the more of LED bars it may have the better flexibility of light pattern control and light distribution uniformity. The LED bars on both side can be but no limited to symmetric each other.

In yet another embodiment, FIG. 6B illustrates a configuration 620 of the LED lighting system where end pieces 622 and 624 may be bent so that the array of LED lighting bars 626 may be oriented according to the end pieces 622 and 624. In one aspect, the configuration 620 may further reduce lamp shadow on the plant.

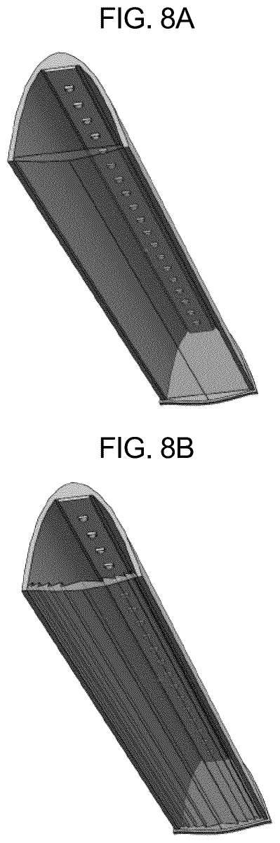

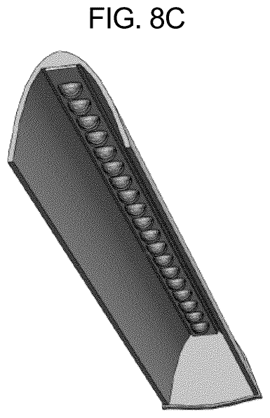

Referring now to FIGS. 8A to 8C, diagrams illustrate three examples of lens designs according to one embodiment. In particular, the designs in FIGS. 8A to 8C may be used with the systems 600 and 620. In one aspect, FIG. 8A illustrates a set of linear lenses; FIG. 8B illustrates a set of Fresnel lenses and FIG. 8C illustrates individual lens on LED. In another embodiment, a combination of the above designs may be used. In yet another embodiment, deflectors may be used as part of the overall designs. In one example, materials such as Polymethylmethacrylate (PMMA), PC, ABS, silicone and glass may be used.

In addition to the brightness control on each segments or panels, the freedom of tilt angle control further increases the flexibility of light pattern control. In one aspect, embodiments of the invention may allow optimize the light distribution pattern for the farm growing different plants with very different height on the same location.

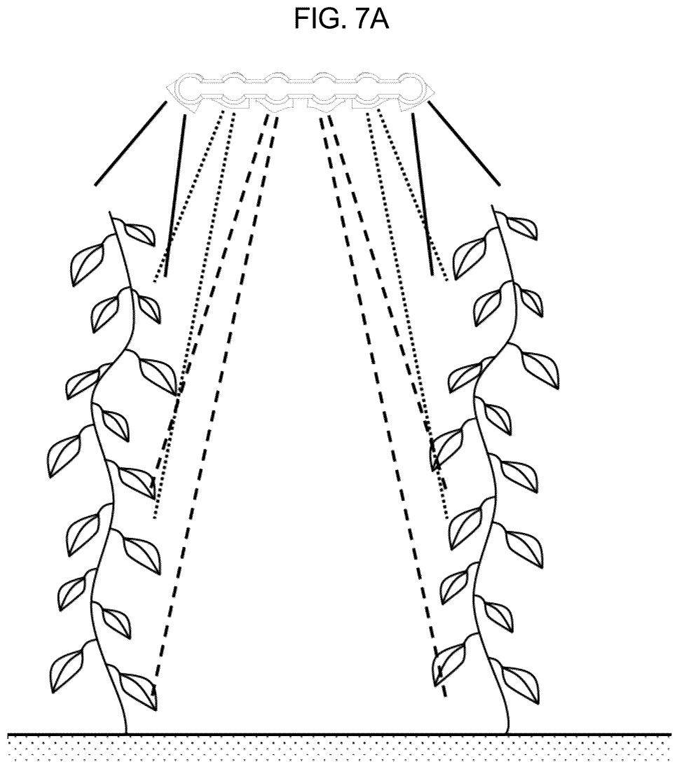

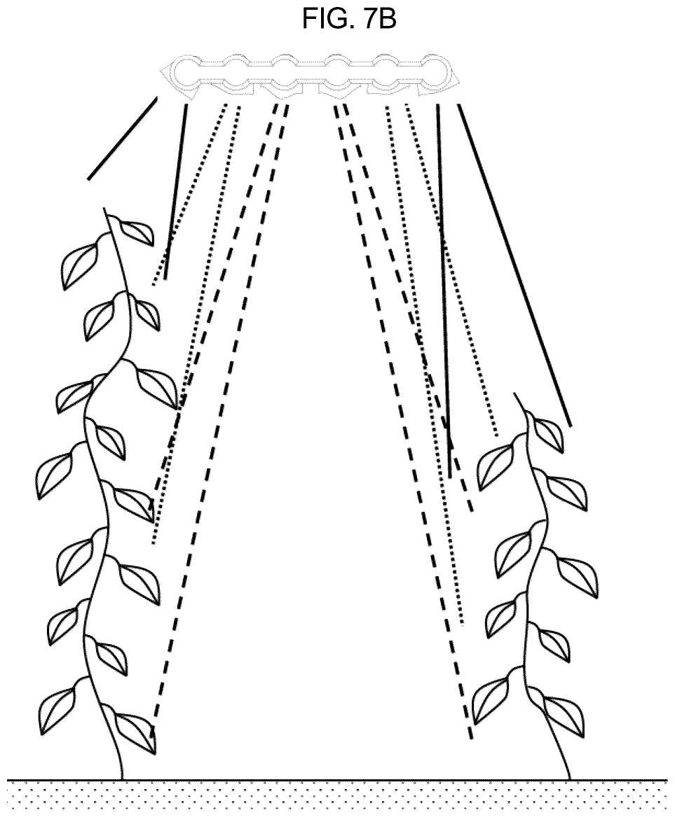

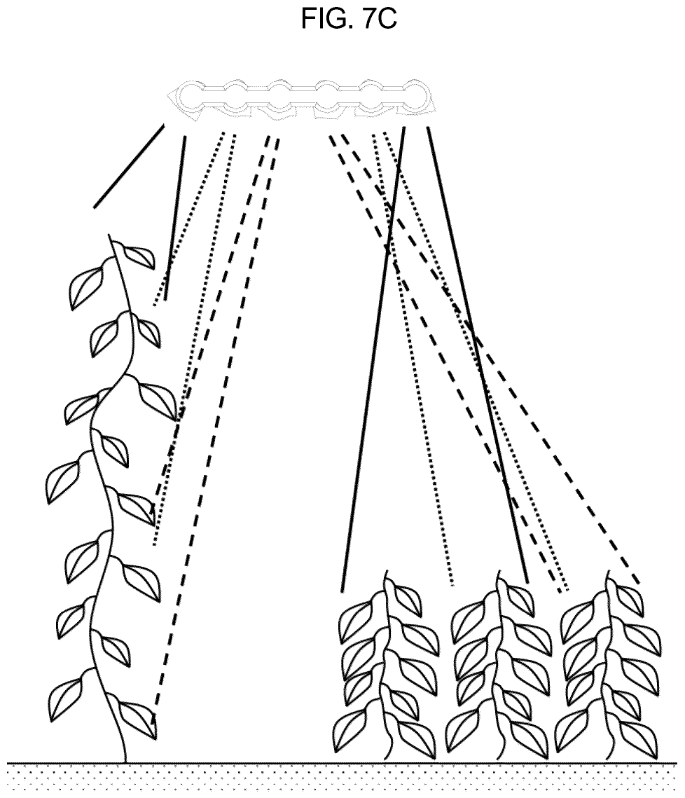

In one aspect, FIGS. 7A to 7C, FIG. 7A may illustrate a diagram showing the system 600 in a horizontal configuration of growing tall plant on both sides. FIG. 7B further illustrates another embodiment where the system 600 in a horizontal configuration of growing plants at different growing stage or height. In yet another embodiment, FIG. 7C illustrates yet another embodiment where the system 600 in a horizontal configuration of growing plants with different height and layout.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A lighting element for horticultural lighting comprising:
a body for housing one or more horticulture lighting units;
wherein the body comprises one or more lighting segments being stationary with respect to the body, wherein each of the one or more lighting segments comprises the one or more horticulture lighting units;
wherein the body comprises different angled planes, wherein the one or more lighting segments are disposed on outward surfaces of the different angled planes;
wherein the one or more lighting units disposed on each of the lighting segments comprise one or more corresponding lens for directing beams of light; and
wherein the one or more lighting segments are pre-configured to provide light beams at various angles as a function of the different angled planes.

2. A lighting system for horticultural lighting comprising:
a body for housing one or more horticulture lighting units;
wherein the body comprises one or more lighting zones being non-movable with respect to the body, wherein each of the lighting zones comprises the one or more lighting units;
wherein the body is bendable to create different angled planes for the one or more lighting zones;
wherein the one or more lighting units disposed on each of the one or more lighting zones comprise one or more corresponding lens for directing beams of light; and
wherein the one or more lighting zones are pre-configured at various angles as a function of the different angled planes.

3. A lighting apparatus for horticultural lighting comprising:
a body for housing one or more horticulture lighting units;
wherein the body comprises one or more lighting panels being stationary with respect to the body, wherein each of the lighting panels comprises the one or more horticulture lighting units;
wherein the body comprises different angled planes, wherein the one or more lighting panels are disposed on outward surfaces of the different angled planes;
wherein the one or more lighting units disposed on each of the one or more lighting panels comprise one or more corresponding lens for directing beams of light;
wherein the one or more lighting panels are configured at various angles as a function of the different angled planes; and
the lens on the one or more lighting units of each of the one or more lighting panels are pre-arranged as a function of the different angled planes.

4. The lighting element for horticultural lighting of claim 1, the one or more corresponding lens of each of the one or more lighting segments are configured to provide different beam light angles.

5. The lighting element for horticultural lighting of claim 4, wherein the beam light angles of each of the one or more lighting segments descend from top to bottom of the different angled planes.

6. The lighting system for horticultural lighting of claim 2, the one or more corresponding lens of each of the one or more lighting zones are configured to provide different beam light angles.

7. The lighting system for horticultural lighting of claim 6, wherein the beam light angles of each of the one or more lighting zones descend from top to bottom of the different angled planes.

8. The lighting apparatus for horticultural lighting of claim 3, the one or more corresponding lens of each of the one or more lighting panels are configured to provide different beam light angles.

9. The lighting apparatus for horticultural lighting of claim 8, wherein the beam light angles of each of the one or more lighting panels descend from top to bottom of the different angled planes.
